(19) United States
(12) Patent Application Publication
(10) Pub. No.: US 2026/0080181 A1
(43) Pub. Date: Mar. 19, 2026

(54) DATA PROCESSING SYSTEMS FACILITATING NATURAL LANGUAGE PROCESSING FOR CONVERSATIONAL DATA

(71) Applicant: Truist Bank, Charlotte, NC (US)

(72) Inventors: Jonathan Henry Kops, Marietta, GA (US); Saloni Uboweja, Cary, NC (US)

(73) Assignee: Truist Bank, Charlotte, NC (US)

(21) Appl. No.: 18/888,606

(22) Filed: Sep. 18, 2024

(51) Int. Cl. G06F 40/35; G06F 40/174; G06N 20/00; H04L 9/40

(52) U.S. Cl. CPC G06F 40/35; G06F 40/174; G06N 20/00; H04L 63/10

(57) ABSTRACT

Systems and methods iteratively train, using training data, a natural language processing (NLP) model to interpret conversational input during a conversation between an agent and a user by predicting key statements to be used in the prediction of a user intent, the training comparing outputs to a target variable during each iteration and adjusting parameters of the NLP model during each iteration to improve predictability of the user intent from the conversational input. Real-time conversational data is transmitted to the NLP model and the trained NLP algorithm derives key statements predicted to indicate intents and predicts one or more user intents based on the data from the conversation. One or more pre-filled forms predicted to effectuate the one or more user intents is generated, the pre-filled forms including generated text derived from information from the data of the conversation, and the form is transmitted to an agent device.

### FIELD OF THE INVENTION

This invention relates generally to the field of data processing systems, and more particularly embodiments of the invention relate to data processing systems facilitating natural language processing for conversational data.

### BACKGROUND OF THE INVENTION

Natural Language Processing (NLP) is a branch of artificial intelligence focusing on the interaction between humans and computers through language. It enables machines to understand, interpret, and generate human speech in a meaningful way. By leveraging advanced algorithms and linguistic data, NLP can perform language recognition tasks to assist humans and streamline business operations. However, many nuances to language are used by each user, which can make it difficult for the computing system to appropriately interpret key information. For example, one example nuance that can be difficult to detect is sarcasm, where the manner in which the words are said may alter the meaning of the words. Thus, a need exists for improved natural language processing systems so that this technology can be more accurate and reliable.

### BRIEF SUMMARY

Shortcomings of the prior art are overcome and additional advantages are provided through the provision of a computing system for data processing systems facilitating natural language processing. The system includes, for instance, a memory, one or more processors in communication with the memory, and program instructions executable by the one or more processors via the memory. Execution of the program instructions, in part, train, using training data, a natural language processing model based on data processing inputs and a selected training algorithm to generate a trained natural language processing model. The training includes iteratively predicting which of one or more key statements should be included in a prediction of one or more user intents, the predicting being based on at least one key statement ascertained from user conversation data. The one or more key statements predicted during each iteration are tested and compared against a target variable, and through a feedback loop, it is indicated for each iteration whether modifications to weights assigned to certain key statements are necessary to improve predictability of the target variable. Calculations used to predict which of one or more key statements should be used in the prediction of one or more user intents are updated by adjusting the weights, thereby reducing the error and improving the predictability of a target variable. The computing system receives, over the network from an agent device, data of a conversation between an agent and a user, and predicts, using the trained natural language processing model and from at least one key statement predicted to indicate intent, one or more user intents of the user from the data of the conversation. Based on the one or more predicted user intents, one or more pre-filled forms predicted to effectuate the one or more predicted user intents are generated and transmitted to the agent device, the one or more pre-filled forms including generated text that includes information derived from the data of the conversations.

Also disclosed herein is a computer-implemented method for data processing systems facilitating natural language processing. The method includes training, by a computer, a natural language processing model based on data processing inputs and a selected training algorithm to generate a trained natural language processing model. The training includes iteratively predicting which of one or more key statements should be included in a prediction of one or more user intents, the predicting being based on at least one key statement ascertained from user conversation data. The one or more key statements predicted during each iteration are tested and compared against a target variable, and through a feedback loop, it is indicated for each iteration whether modifications to weights assigned to certain key statements are necessary to improve predictability of the target variable. Calculations used to predict which of one or more key statements should be used in the prediction of one or more user intents are updated by adjusting the weights, thereby reducing the error and improving the predictability of a target variable. The computing system receives, over the network from an agent device, data of a conversation between an agent and a user, and predicts, using the trained natural language processing model and from at least one key statement predicted to indicate intent, one or more user intents of the user from the data of the conversation. Based on the one or more predicted user intents, one or more pre-filled forms predicted to effectuate the one or more predicted user intents are generated and transmitted to the agent device, the one or more pre-filled forms including generated text that includes information derived from the data of the conversations.

Additionally, disclosed herein is a computing system that includes a memory, one or more processors in communication with the memory, and program instructions executable by the one or more processors via the memory. Execution of the program instructions, in part, train, using training data, a natural language processing model based on data processing inputs and a selected training algorithm to generate a trained natural language processing model. The training includes iteratively predicting which of one or more key statements should be included in a prediction of one or more user intents, the predicting being based on at least one key statement ascertained from user conversation data. The one or more key statements predicted during each iteration are tested and compared against a target variable, and through a feedback loop, it is indicated for each iteration whether modifications to weights assigned to certain key statements are necessary to improve predictability of the target variable. Calculations used to predict which of one or more key statements should be used in the prediction of one or more user intents are updated by adjusting the weights, thereby reducing the error and improving the predictability of a target variable. The computing system receives, over the network from an agent device, data of a conversation between an agent and a user, and predicts, using the trained natural language processing model and from at least one key statement predicted to indicate intent, one or more user intents of the user from the data of the conversation. Based on one or more predicted user intents, the system correlates one or more fillable forms to the one or more predicted user intents, the one or more fillable forms including form fields for entering information, and transmits, to the user device, the one or more fillable forms.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system, and environment thereof for data processing systems facilitating natural language processing, in accordance with an embodiment of the present invention;

FIG. 2A is a diagram of a feedforward network, according to at least one embodiment, utilized in machine learning;

FIG. 2B is a diagram of a convolution neural network, according to at least one embodiment, utilized in machine learning;

FIG. 2C is a diagram of a portion of the convolution neural network of FIG. 2B, according to at least one embodiment, illustrating assigned weights at connections or neurons;

FIG. 3 is a diagram representing an exemplary weighted sum computation in a node in an artificial neural network;

FIG. 4 is a diagram of a Recurrent Neural Network RNN, according to at least one embodiment, utilized in machine learning;

FIG. 5 is a schematic logic diagram of an artificial intelligence program including a front-end and a back-end algorithm;

FIG. 6 is a flow chart representing a method, according to at least one embodiment, of model development and deployment by machine learning;

FIG. 7 is a flow chart representing a method, according to at least one embodiment, of a spoken dialog system;

FIG. 8 is a flow chart representing a method, according to at least one embodiment, of natural language processing; and

FIG. 9 is a flow chat representing a method, according to at least one embodiment, of natural language processing.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

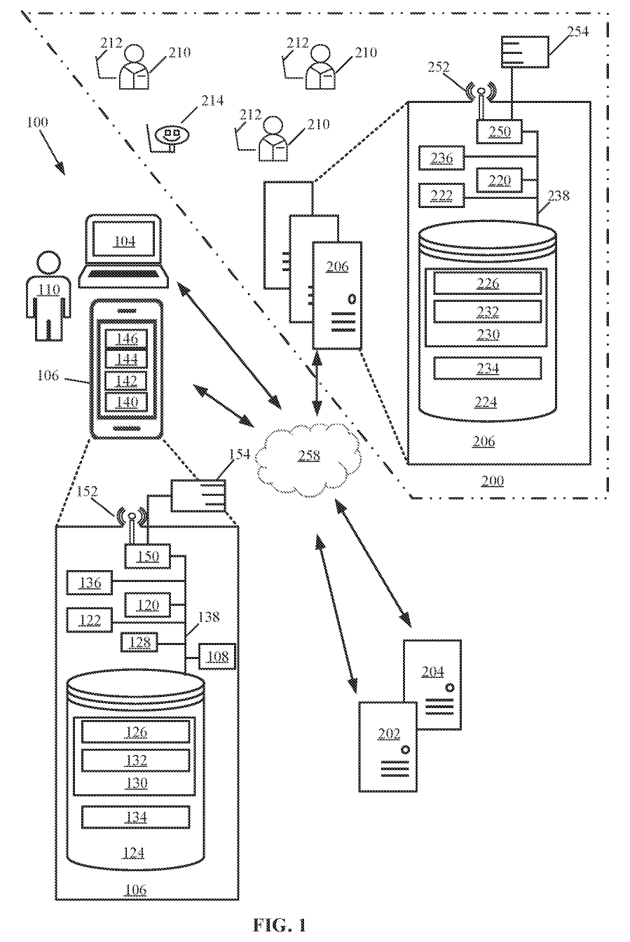

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user’s eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly – by way of intermediate component(s) – with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met. In an embodiment the enterprise system 200 records user interactions with the virtual agent 214 in a user log. Should the system determine that the user needs the assistance of a human agent 210, the system may transmit the recorded user interactions to the agent device 212 of the human agent 210 to contextualize the user interaction. In an example, a user interacting with a virtual agent 214 indicates, through a series of messages, that they are a pre-existing customer with the enterprise that wants to open a new account for their minor child. When the user is referred to one or more human agents 210, they will receive a transmission regarding the interaction(s) the user had with the virtual agent 214 and contextualizing that the user wants to open an account for their minor child. The transmission will allow for the human agent 210 to lower the amount of time spent speaking with a client (a commonly tracked metric in a call center environment) and provide user satisfaction with a quicker response. In an embodiment, this transmission may be a summary of the interaction(s) the user had with the virtual agent 214. In an embodiment, this transmission may be a full transcript of the interaction(s) the user had with the virtual agent 214.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between -1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

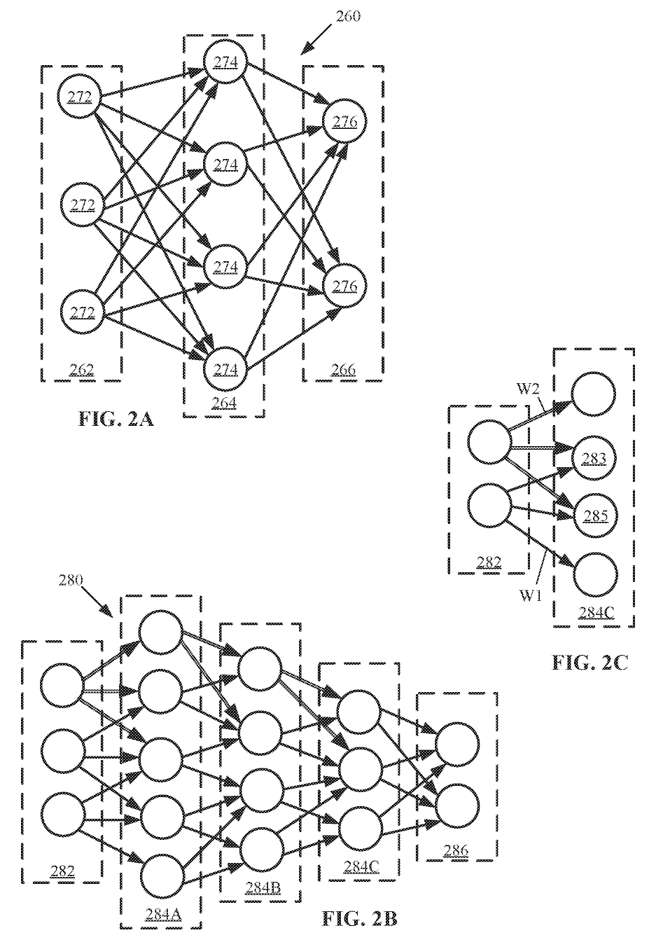

An artificial neural network (ANN), also known as a feedforward network, may be utilized, e.g., an acyclic graph with nodes arranged in layers. A feedforward network (see, e.g., feedforward network 260 referenced in FIG. 2A) may include a topography with a hidden layer 264 between an input layer 262 and an output layer 266. The input layer 262, having nodes commonly referenced in FIG. 2A as input nodes 272 for convenience, communicates input data, variables, matrices, or the like to the hidden layer 264, having nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers, e.g., an activation function implemented between the input data communicated from the input layer 262 and the output data communicated to the nodes 276 of the output layer 266. It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

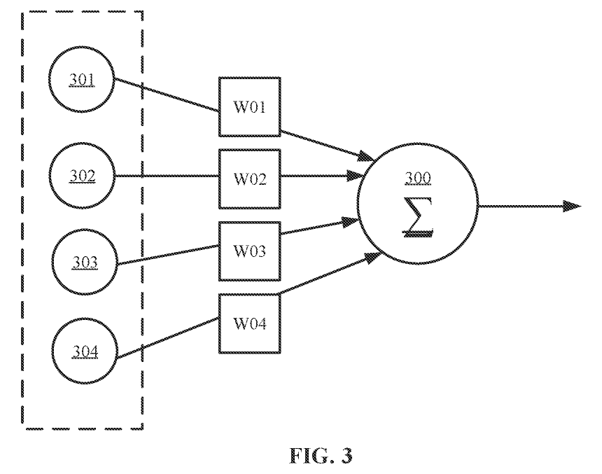

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

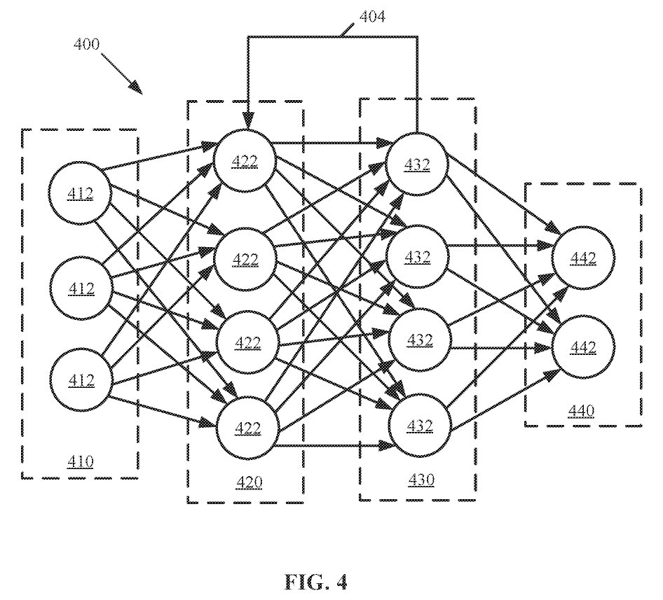

An example for a Recurrent Neural Network RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more and up to all of the nodes of a subsequent layer may provide or communicate a parameter or other data to a previous layer of the RNN 400. Moreover and in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them, i.e., nodes of nonsequential layers of the RNN 400.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

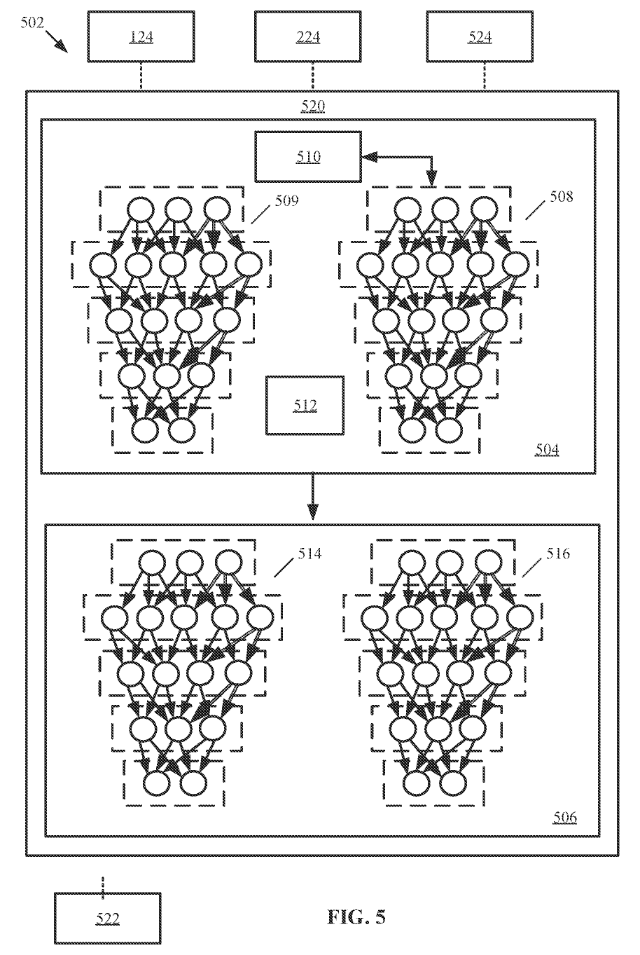

Referring now to FIG. 5 and some embodiments, an AI program 502 may include a front-end algorithm 504 and a back-end algorithm 506. The artificial intelligence program 502 may be implemented on an AI processor 520, such as the processing device 120, the processing device 220, and/or a dedicated processing device. The instructions associated with the front-end algorithm 504 and the back-end algorithm 506 may be stored in an associated memory device and/or storage device of the system (e.g., storage device 124, memory device 122, storage device 224, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

Additionally or alternatively, the front-end program 504 can include one or more AI algorithms 510, 512 (e.g., statistical models or machine learning programs such as decision tree learning, associate rule learning, recurrent artificial neural networks, support vector machines, and the like). In various embodiments, the front-end program 504 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 508 and/or AI algorithm 510 may be used for image recognition, input categorization, and/or support vector training. In some embodiments and within the front-end program 504, an output from an AI algorithm 510 may be communicated to a CNN 508 or 509, which processes the data before communicating an output from the CNN 508, 509 and/or the front-end program 504 to the back-end program 506. In various embodiments, the back-end network 506 may be configured to implement input and/or model classification, speech recognition, translation, and the like. For instance, the back-end network 506 may include one or more CNNs (e.g., CNN 514) or dense networks (e.g., dense networks 516), as described herein.

For instance and in some embodiments of the AI program 502, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known, e.g., a mix of labeled and unlabeled data having the same distribution.

In some embodiments, the AI program 502 may be accelerated via a machine-learning framework 522 (e.g., hardware). The machine learning framework may include an index of basic operations, subroutines, and the like (primitives) typically implemented by AI and/or machine learning algorithms. Thus, the AI program 502 may be configured to utilize the primitives of the framework 522 to perform some or all of the calculations required by the AI program 502. Primitives suitable for inclusion in the machine learning framework 522 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

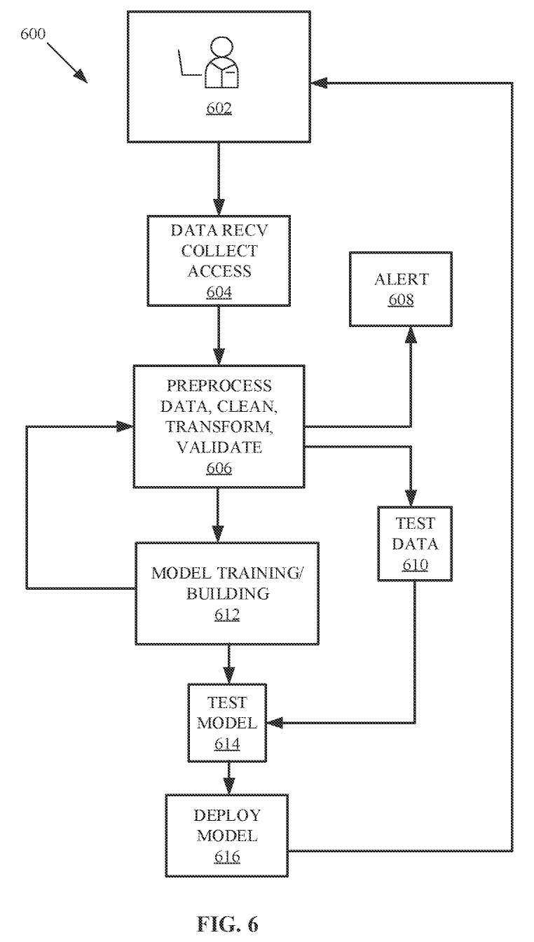

FIG. 6 is a flow chart representing a method 600, according to at least one embodiment, of model development and deployment by machine learning. The method 600 represents at least one example of a machine learning workflow in which steps are implemented in a machine-learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In an example, the machine learning workflow may facilitate a simulated virtual assistant assisting a human agent in completing tasks on the behalf of a user. In a first iteration from the user perspective, step 602 can represent a starting point. However, with regard to continuing or improving an ongoing machine learning workflow, step 602 can represent an opportunity for further user input or oversight via a feedback loop.

In step 604, data is received, collected, accessed, or otherwise acquired and entered as can be termed data ingestion. In an example, the data in step 604 may be previously recorded interactions between human agents and customers. Non-limiting examples of previously recorded data to be used in the training and testing process are audio data or written data. In step 606, the data ingested in step 604 is pre-processed, for example, by cleaning, and/or transformation such as into a format that the following components can digest. In an example, previously recorded interactions between human agents and customers over the phone may be transcribed into text. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated. Step 606 can include data validation, which focuses on confirming that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples. In an example, the model may be used to aid human agents and users in a help desk setting.

The systems and methods disclosed herein provide an improvement to existing technology by aiding agents in solving user problems. The system “listens in” on communications between help desk agents and users, utilizing a natural language processing algorithm to predict (i) the user’s problem and (ii) how to solve the problem. As the user and the agent interact, the system identifies key phrases to generate a prediction of one or more user intents.

One example of a key phrase incorporates an adjacency pair. Adjacency pairs are pairs of sentences or phrases used in communications between two or more people. The first pair part of the adjacency pair conjures a logical response known as the second pair part. In an example, a customer calls a bank to cancel their credit card. The customer says to the agent “I’m calling today because I lost my wallet.” The help agent responds, “Which cards did you have in your wallet when you lost it?” Without an explicit confirmation of the fact that the customer intends to cancel or freeze the cards they lost, the system can infer, from these first and second pair parts, that the customer no longer has access to the cards and that one or more actions must be taken to secure the user’s cards and account. Key phrases may capture parts of an adjacency pair, or they may capture other important words or phrases in the conversation. Non-limiting examples of key phrases may include “credit card”, “cancel”, “change address”, or “check balance”.

Using the identified key phrases, the system can make one or more predictions to determine one or more problems the user may be calling to remedy. Furthermore, the system can generate solutions to the problem(s) and transmit those solutions to the agent. In the earlier example of the lost credit cards, the system may, after determining that the customer has lost access to one or more cards, generate a card cancellation form and initiate display of the form on an agent device or a user device.

The source identification software service determines the telephone number of the incoming call source as incoming telephone number data using techniques that can include, for example, automatic number identification (“ANI”). In that case, the incoming interaction initialization data can be ANI data, which is generally transmitted along with an incoming telephone call using multi-frequency signaling, which can be a digital tone that is translated to a numeric value. For Voice-over-Internet Protocol (“VoIP”) calling, the incoming telephone number can instead be received as packets of digital information within the incoming interaction initialization data. The source identification software service processes the incoming interaction initialization data (i.e., the ANI data or IP data packets) to determine the source data as incoming telephone number data. The provider system uses the incoming telephone number data to query an internal end user database, such as storage device, to determine whether the incoming telephone number corresponds to an existing provider customer. When a user initiates a provider-user interaction by communicating with a provider through written electronic communications or VoIP, the communications originate from a user computing device, such as a personal computer, a smart phone, or tablet computing device. In that instance, the source identification software service processes the incoming initialization data to capture or determine user source data that can include a user device IP address for the user computing device, a phone number, etc. The enterprise system may utilize the user source data to transmit a query to the provider’s internal end user database to determine if an existing database record matches user source data. In this manner, either the incoming telephone number, the user device IP address, email address, or other user source data is used to determine to identity of the end user and whether the user is a current or former provider customer.

The end user database may comprise database records that correspond to individual customers, or end users. The end user database records may store a variety of end user data, including, without limitation: (i) a user identifier; (ii) user contact data, including a mailing address or a geographic region where the user resides (e.g., a zip code, city, state); (iii) user source data, such as user telephone number data, user device IP Address data, an email address, or a social media account name; (iv) user demographic data, including the gender, age, and/or regional dialect of a user; (v) one or more product identifiers that indicate the accounts or products currently held by a user (e.g., a checking account, a home loan, brokerage account, etc.); (vi) user resource availability data (e.g., balances for various product types or account types associated with, or held by, a user); (vii) average resource availability data that indicates the average value of products or account balances maintained by the user over a given time period (e.g., an average monthly balance for a financial/bank account held by the user); (viii) transaction data that includes data and information relating to user transactions, such as payment amounts, dates when a transaction occurred, data that identifies other parties to the transaction (i.e., a payment recipient), and information identifying a category of expenditures for the transaction (i.e., groceries, transportation, etc.); (ix) average resource utilization volume data indicating the average number of transactions a user conducts using a given product over a given time period (e.g., the number of resource expenditures per month for a given account or accounts); (x) user online activity data indicating user attempts to log into the provider system to access user accounts or other activities performed by users online or through a dedicated mobile device software application; or (xi) system configuration data, as described herein.

According to various embodiments, the end user database can also include interaction activity data that in part overlaps with data stored to the interaction database. That is, the interaction activity data represents information characterizing prior shared experiences between the particular user and the provider, such as a history of user calls to a provider seeking technical support assistance. In particular, the interaction activity data can include, without limitation: (i) sequencing data; (ii) subject identifier data; (iii) interaction driver identifier data; (iv) sentiment data; (v) polarity data; (vi) user source data (e.g., did the user utilize a telephone, email, or other means to initiate the interaction); (vii) an agent identifier; and (viii) resolution data.

The enterprise system can further determine geographic location data based on the incoming telephone number data or user device IP address. The provider system can include a software application that transmits the incoming telephone number data or the user device IP address to an Identity & Location API that utilizes the phone number or IP Address to determine the approximate geographic location of the user computing device. The Identity & Location API can pass the incoming telephone number or user device IP address to a database or a third-party software service that returns geographic location data corresponding to an approximate geographic location for the telephone number or the user device IP address, such as a city, county, or state. The Identity & Location API stores the geographic data to a database record with user data and/or content data.

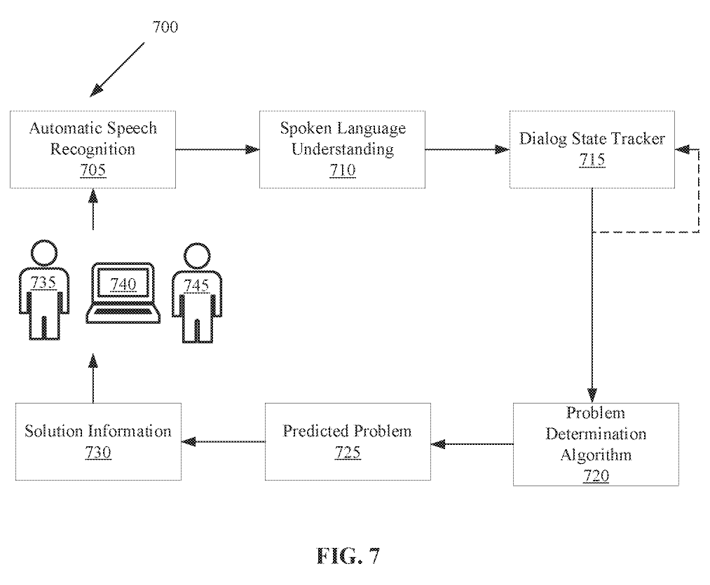

FIG. 7 is a representation of a spoken dialog system 700 for spoken conversation between an agent and a user. Both the agent 735 and the user 745 produce audio as they speak and interact with one another. A microphone detects the audio signals and the input audio signals may be processed using a content driver software service that processes various data using NLP technology that is implemented by one or more artificial intelligence software applications and/or systems. The artificial intelligence software applications and/or systems may be implemented, according to various embodiments, neural networks. NLP technology analyzes one or more content data files (e.g., audio files) that include various communication elements such as (a) alphanumeric data composed of individual words, symbols, numbers, (b) vocal qualities or speech patterns, (c) stylistic communication approaches (e.g., abbreviations, acronyms, etc.), and/or (d) various other communication elements that provide meaningful communicative features.

Automatic speech recognition (ASR) algorithms 705 convert the audio of the user and the audio of the agent into text form for analysis. ASR algorithms 705 can use a combination of machine learning algorithms and large language models to analyze speech and convert it into a text form. This text form is then converted into a meaning representation using spoken language understanding (SLU) algorithms 710. SLU algorithms 710 use speech processing and Natural Language Processing (NLP) to extract meaning from speech and determine what a user or agent may want. SLU algorithms 710 may include the identification of adjacency pairs. In an embodiment where the user and the agent are not speaking the same language, SLU algorithms 710 may perform translation using a Large Language Model (LLM) or other Machine Learning (ML) techniques to facilitate communication between the agent and the user.

The audio signal is first pre-processes using a reduction analysis to remove unqualified audio data (e.g., background noise) that does not meaningfully contribute to the subject classification analysis. The reduction operation removes certain content data according to criteria defined by a provider. For instance, the reduction analysis can determine whether content data files are “empty” and contain no recorded linguistic interaction between a provider agent and a user, and designate such empty files as not suitable for use in a subject classification analysis. The reduction analysis can also perform a contradiction operation to remove contradictions from the audio data. Reduction analysis includes removing or replacing abbreviated words or phrases that can cause inaccuracies in a subject classification analysis.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

The meaning representation derived by the SLU algorithm 710 is input into a dialog state tracker 715. The dialog state tracker 715 updates the state of the dialog as the conversation flows and logs these states as estimated dialog states. The estimated dialog states inform the problem determination algorithm 720, which predicts the one or more problems it believes the user is facing. As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (i.e., using n-gram predictions with Kneser-Ney smoothing) using a simple neural network. Suitable neural network architectures for such purpose include a skip-gram architecture.

The problem determination algorithm works in conjunction with a computing system to derive a predicted problem 725. Audio data may be processed with specific business rules that are deterministically defined based on business goals. For instance, once the input text data and/or input audio data has been interpreted by the NLU system, the NLG system may incorporate various considerations into generating text that achieves a communicative goal of the enterprise business. The NLU system may incorporate, according to various embodiments, a confidence/probability score and/or a lattice of hypotheses with each hypothesis corresponding to a confidence/probability score representing the likelihood that words are intended to have a certain meaning/interpretation. According to one embodiment, in order for the NLU system to generate an output to the NLG system, the confidence/probability score may need to satisfy or surpass a predetermined confidence threshold. If the NLU system is unable to interpret the words in a manner that satisfies the predetermined confidence threshold, an automated response may request that the user repeat the information provided.

The dialog state tracker may incorporate a relational database that maintains the input audio data, transcribed data and/or various other user or content data in a manner that permits the content of such data to be associated with certain information such as, for example, the user, a purpose for why the user initiated the interaction with the enterprise system, or various other identifiers or content metadata. Storing such input audio data and/or transcribed data to a relational database further facilitates expedient sorting of the data, such as retrieving user or content data having certain subject matter, customers, times and dates, etc. The enterprise system may maintain the interaction or relational database that stores such data in order to access this data in future user interactions. Metadata that can be accessed by the enterprise system may include, for example, (a) sequencing data representing the date and time when the data was created or otherwise representing an order or sequence in which user interaction occurred, (b) subject identifier data that characterizes the purpose (e.g., subjects or topics) for the user interaction (e.g., “technical support,” “make changes to user account,” “make a payment,” etc.), (c) weighting data representing the relative importance of various qualities or speech patterns (e.g., timbre, tone, cadence, etc.) specific to the user based on the interaction between the user and the enterprise system having a desired resolution or outcome, where the success of certain qualities being based on user responses, customer feedback, agent feedback, etc., (d) source identifier data identifying the user such as, for example, a name of the user, an affiliated employer or business, a job title or role, etc., (e) provider identifier data identifying the owner of the data (e.g., the entity that operates the enterprise system), (f) user source data such as a telephone number, email address, user device internet protocol (IP) address, (g) sentiment data including sentiment identifiers (e.g., how the user responds or feels in relation to certain communication elements or qualities that take place during a user interaction with the enterprise system), (h) polarity data indicating the relative positive or negative degree of sentiment occurring during a user interaction, (i) resolution data indicating whether a particular user’s issue was resolved or not, and if resolved how the issue was resolved (e.g., if the issue is that the user forgot a password and the resolution was that the password was reset), (j) agent identifier data identifying a human agent 210 or whether the virtual agent 214 interacted with the user 110 in the past, and/or (k) other types of data that can be helpful for future user interactions between various users and the enterprise system. Based on the predicted problem 725, the problem determination algorithm 720 transmits solution information 730 to an agent 735 utilizing an agent device 740. Should the predicted problem 725 or the solution information 730 be incorrect, the system can iterate through the method,

Some user interactions between the user and the enterprise system may be initiated when a user contacts a provider through an incoming interaction request. The incoming interaction request may include, according to various examples, a phone call that includes input audio data, a chat or an email providing incoming interaction initialization data, which can be multi-frequency signal tones or data packets representing a user device IP address, email address, or digital routing information, or even a video call, which may incorporate input audio data as well as input video data. Once the user interaction is initiated, the enterprise system may include a source identification software service that processes incoming interaction initiation data to generate user source data (e.g., a telephone number, a user device IP address, an email address, a user account name, etc.).

Prior to conducting a subject analysis to ascertain subjects identifiers in the content data (i.e., topics or subjects addressed in the content data) or interaction driver identifiers in the content data (i.e., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency–inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (i.e., topics) addressed within the content data. The subject classification analysis can specifically identify one or more interaction driver identifiers that are the reason why a user initiated the interaction. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (i.e., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recalculated, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (i.e., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used).

The content driver software service can also incorporate Part of Speech (“POS”) tagging software code that assigns words a parts of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (i.e., a content source).

The content driver software service can also perform a sentiment analysis to determine sentiment from the content data. Sentiment can indicate a view or attitude toward a situation or an event. Further, identifying sentiment in data can be used to determine a feeling, emotion or an opinion.

The content driver software service can also apply machine learning software to determine sentiment, including use of such techniques to determine both polarity and emotional sentiment. Machine learning techniques also start with a reduction analysis. Words are then transformed into numeric values using vectorization that is accomplished through a bag-of-words model, Word2Vec techniques, or other techniques known to those of skill in the art. Word2Vec, for example, can receive a text input (e.g., a text corpus from a large data source) and generate a data structure (e.g., a vector representation) of each input word as a set of words.

Each word in the set of words is associated with a plurality of attributes. The attributes can also be called features, vectors, components, and feature vectors. For example, the data structure may include features associated with each word in the set of words. Features can include, for example, gender, nationality, etc. that describe the words. Each of the features may be determined based on techniques for machine learning (e.g., supervised machine learning) trained based on association with sentiment.

Training the neural networks is particularly important for sentiment analysis to ensure parts of speech such as subjectivity, industry specific terms, context, idiomatic language, or negation are appropriately processed. For instance, the phrase “Our rates are lower than competitors” could be a favorable or unfavorable comparison depending on the particular context, which should be refined through neural network training.

Machine learning techniques for sentiment analysis can utilize classification neural networking techniques where a corpus of content data is, for example, classified according to polarity (e.g., positive, neural, or negative) or classified according to emotion (e.g., satisfied, contentious, etc.).

For some embodiments, the content driver software service can be configured to determine relationships between and among subject identifiers and sentiment identifiers. Determining relationships among identifiers can be accomplished through techniques, such as determining how often two identifier terms appear within a certain number of words of each other in a set of content data packets. The higher the frequency of such appearances, the more closely the identifiers would be said to be related.

One advantage of the systems and methods disclosed herein is that they are able to remove background sounds and other information that is not essential for generating forms. artificial neural networks with deep neural networks may be incorporated into a natural language processing model to promote separation of features during clustering by mapping the feature representations to the embedding space. Clustering may then be performed on these feature representations to separate noises into different sources, which can be used to identify the identify the key statements needed to generate the form. One embodiment of the system partitions embedding vectors assigned as a function of the audio signal into clusters corresponding to different sources of the noise. Binary masks may be applied to the clusters to create masked clusters to indicate which portions of a signal should be included or excluded. In one embodiment, waveforms from the audio signal are synthesized from the masked clusters where each waveform corresponds to a different source of the noise. The waveforms may be synthesized by converting the masked clusters into separate signals in the time domain corresponding to the different sources in the mixed audio signal, using inverse short-time Fourier transform (STFT). STFT may utilize a series of Fourier transforms of small windows or frames of the signal. For example, the signal may be divided into various frames of equal length and for each frame various features such as pitch, variance, and rate are extracted and represented by a matrix. The separated waveforms may then be pieced together to create a new speech signal that excludes the unwanted noise from other audio sources. Advantageously, this newly generated signal no longer includes extraneous signals from unwanted noise sources, which reflects a technical improvement in natural language processing systems.

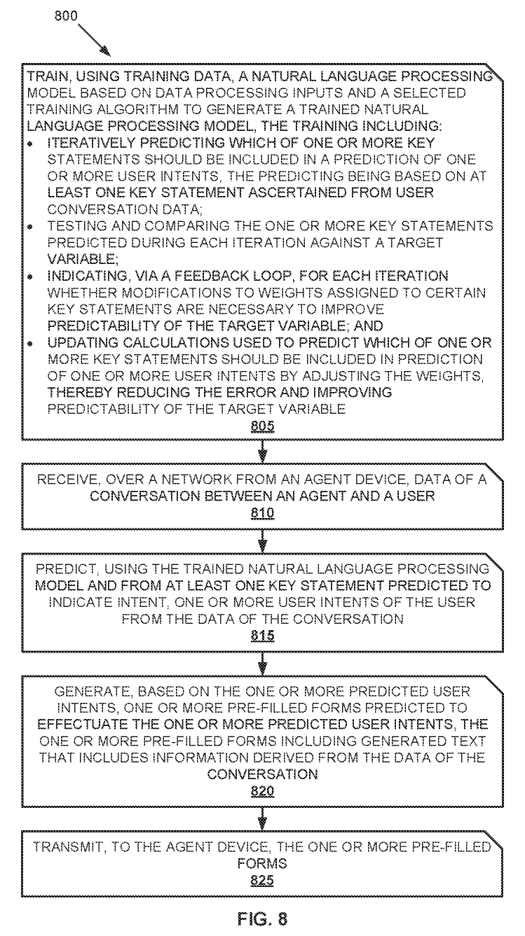

FIG. 8 is a block diagram of an example method 800 for natural language processing. At block 805, the system iteratively trains, using training data, a natural language processing model to based on data processing inputs and a selected training algorithm to generate a trained natural language processing model. In particular, the natural language processing model is trained to interpret conversational inputs during communication by predicting key phrases and intents from the conversational inputs. The training includes iteratively predicting which of one or more key statements should be included in a prediction of one or more user intents, the predicting being based on at least one key statement ascertained from user conversation data. The training also includes testing and comparing the one or more key statements predicted during each iteration against a target variable. The training also includes indicating, via a feedback loop, for each iteration whether modifications to weights assigned to certain key statements are necessary to improve predictability of the target variable. The training also includes updating calculations used to predict which of one or more key statements should be included in prediction of one or more user intents by adjusting the weights, thereby reducing the error and improving predictability of the target variable. Accordingly, the natural language processing model compares outputs to a target variable during each iteration and adjusts parameters of the model during each iteration to improve predictability of key phrases and intents from the conversational inputs. In an example, the training data used in the training and testing dataset may be an audio dataset, a written dataset, or a combination thereof.

At block 810, the system receives, over a network from an agent device, data of a conversation between an agent and a user. In an example, the conversation between the agent and the user may be an in-person face-to-face interaction/communication, such as an interaction between a teller and a customer in a branch location. In another example, the conversation between the agent and the user is a conversation over the phone. In another example, the conversation between the agent and the user is a conversation over a Short Message Service (SMS), text messages, or an Internet messaging app. Context regarding the user conversation may be collected during a pre-screening phase of a conversation. Non-limiting examples of context may include user interaction with graphical user interfaces with selectable options that categorize a user’s problem, menu buttons to be pressed by the user before the initiation of a phone call, or the user’s selection of a certain queue in a physical customer service location.

In one embodiment, to be compliant with state and federal regulations regarding recording conversations, the user may receive an indication at the beginning of the conversation that a natural language processing algorithm is being utilized. In accordance with the laws of some jurisdictions, the user may have the option to opt out of the usage of the natural language processing model, therefore terminating the system and methods as disclosed herein.

At block 815, the system, utilizing the trained natural language processing model and at least one key statement predicted to indicate intent, predicts one or more user intents of the user from the data of the conversation. A standard industry term for commands communicated to digital assistants and chatbots is an “intent”. An intent is an intersection of what the user inputs into a device or speaks aloud and what a natural language processing model determines the user intended to execute. A user may interact with an agent utilizing a computing device loaded with a natural language processing model. A natural language processing model triggers, for example, an account intent when a user indicates that they would like to change their billing address. An entity interaction model is a collection of intents created by the entity. Non-limiting examples of intents may include account intents, transfer intents, authorization intents, or fraud intents.

At block 820, the system generates, based on the one or more user intents, one or more pre-filled forms predicted to effectuate the one or more predicted user intents, the one or more pre-filled forms including generated text that includes information derived from the data of the conversation. In particular, pre-filling the form may include identifying one or more form fields of a pre-existing form and auto-filling the one or more form fields with the generated text. Because a user may raise more than one problem during the conversation, the system may predict more than one problem associated with the conversation, and therefore generate more than one form. In an embodiment, multiple user intents will be effectuated by the same form. In an example, a customer has gotten married and moved into a new home with their new spouse. The customer will need to change both their name and address within the system. The system can, in the example, generate a single change of information form that solves both issues that the user is facing. Non-limiting examples of common user problems include being locked out of an account, losing a password, losing access to one or more cards associated with an account, changing the user’s name or address, or creating a new account. In an embodiment, the pre-filled form generated by the system is derived from a database of known solutions provided by the entity the user is requesting assistance from. The pre-filled form may also be derived by a machine learning algorithm trained on previous user/agent interactions regarding user problems. In some embodiments, the generated text used to fill out the form further includes additional information derived from a user profile of the user. For example, if the pre-filled form is a loan application, the generated text may include information about the user (e.g., name, address, etc.) in addition to information obtained from the call (e.g., loan amount, loan terms, etc.). In some embodiments, the additional information is derived from stored data selected from the group consisting of personal data, demographic data, transactional data, behavioral data, user engagement data, customer feedback data, and attitudinal data.

At block 825, the system transmits the one or more pre-filled forms to the agent device. At times, the system may improperly generate pre-filled forms or the user may also improperly communicate their desires, leading the system to generate a form that does not properly effectuate the user’s one or more intents. In this case, the agent may indicate to the system that the pre-filled forms do not correlate with the user intent. Accordingly, the system receives, via the network in response to the one or more pre-filled forms being transmitted, an indication that the one or more pre-filled forms do not correlate with the one or more predicted user intents. The system will generate and transmit one or more updated pre-filled forms. In an embodiment in which the form itself does not correlate with the user intent. The system may, in this embodiment, generate a different pre-filled form using some or all of the information filled into the previous form. In another embodiment, the information filled into the form is incorrect. The system may, in this embodiment, generate the same form, but with updated information pre-filled into the form. Further, the system may use the feedback provided by the agent to retrain the natural language processing model based on the indication, where the retraining adjusts the weights to improve predictability of the natural language processing model in future predictions.

In some embodiments, certain forms need customer approval in order to be submitted and/or accepted by a customer. To effectuate this process, the system may receive, from the agent device and in response to transmitting the one or more pre-filled forms to the agent device, an authorization indication authorizing transmission of the one or more pre-filled forms to a user device of the user. This authorization may indicate that the information that was included in the pre-filled form is accurate and that the prediction about what form to provide and what information to include in the form was correct. Once the authorization is received, the system may transmit (e.g., using email, text, or otherwise communicate (e.g., display if the interaction is a video conference)) the one or more pre-filled forms to the user device for review by the user.

In some embodiments, the one or more pre-filled forms are transmitted to the agent device in real time during the conversation and the one or more pre-filled forms are transmitted to the user device in real time during the conversation. This may allow the customer to review and confirm the information that the agent plans to submit with the pre-filled form and provide an acknowledgement or approval for the submission by the agent.

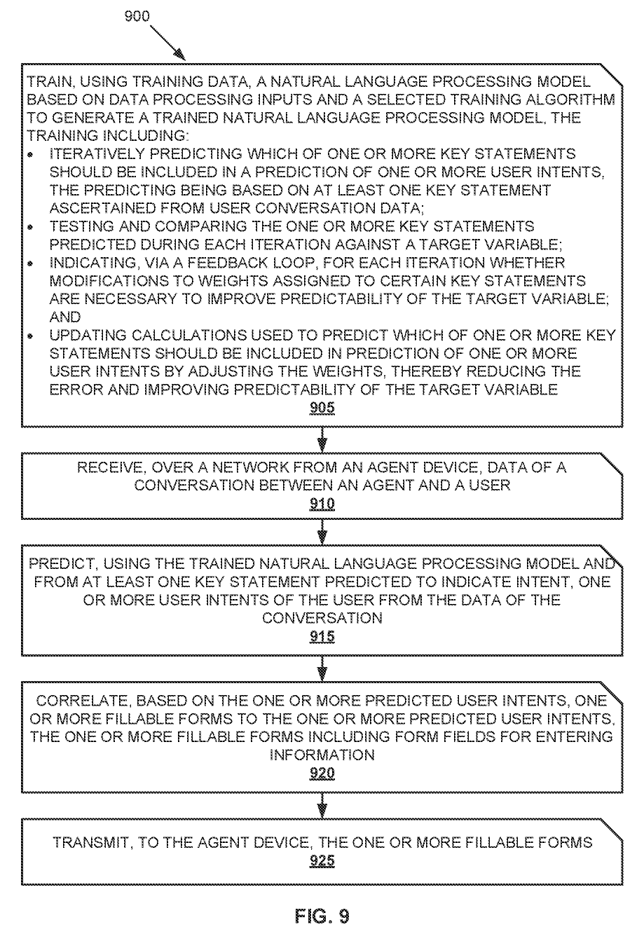

FIG. 9 is a block diagram of an example method 900 for natural language processing. At block 905, the system iteratively trains, using training data, a natural language processing model to interpret conversational inputs during communication by predicting key phrases and intents from the conversational inputs. The training compares outputs to a target variable during each iteration and adjusts parameters of the model during each iteration to improve predictability of key phrases and intents from the conversational inputs.

At block 910, the system receives, over a network from an agent device, data of a conversation between an agent and a user. In an example, the conversation between the agent and the user may be a face-to-face interaction, such as an interaction between a teller and a customer in a branch location. In another example, the conversation between the agent and the user is a conversation over the phone. In another example, the conversation between the agent and the user is a conversation over a Short Message Service (SMS) or text messages. Context regarding the user conversation may be collected during a pre-screening phase of a conversation. Non-limiting examples of context may include user interaction with graphical user interfaces with selectable options that categorize a user’s problem, menu buttons to be pressed by the user before the initiation of a phone call, or the user’s selection of a certain queue in a physical customer service location.

At block 915, the system, utilizing the trained natural language processing model and at least one key statement predicted to indicate intent, predicts one or more user intents of the user from the data of the conversation. A standard industry term for commands communicated to digital assistants and chatbots is an “intent”. An intent is an intersection of what the user inputs into a device or speaks aloud and what a natural language processing model determines the user intended to execute. A user may interact with an agent utilizing a computing device loaded with a natural language processing model. A natural language processing model triggers, for example, an account intent when a user indicates that they would like to change their billing address. An entity interaction model is a collection of intents created by the entity. Non-limiting examples of intents may include account intents, transfer intents, authorization intents, or fraud intents.

At block 920, the system generates, based on the one or more user intents, one or more fillable forms predicted to effectuate the one or more predicted user intents, the one or more fillable forms including fields for entering information. In an embodiment, the fillable form is partially filled by the system, and only certain fields must be filled out by the agent or the user. Because a user may raise more than one problem during the conversation, the system may predict more than one problem associated with the conversation, and therefore generate more than one form. In an embodiment, the system may be governed by certain prioritization metrics or rules that instruct the system to prioritize certain types of forms or certain user intents. In an embodiment, multiple user intents will be effectuated by the same form. In an example, a customer has gotten married and moved into a new home with their new spouse. The customer will need to change both their name and address within the system. The system can, in the example, generate a single change of information form that solves both issues that the user is facing. Non-limiting examples of common user problems include being locked out of an account, losing a password, losing access to one or more cards associated with an account, changing the user’s name or address, or creating a new account. In an embodiment, the fillable form generated by the system is derived from a database of known solutions provided by the entity the user is requesting assistance from. In another embodiment, the fillable form may also be derived by a machine learning algorithm trained on previous user/agent interactions regarding user problems.

At block 925, the system transmits the one or more fillable forms to the agent device. At times, the system may improperly generate pre-filled forms. The user may also improperly communicate their desires, leading the system to generate a form that does not properly effectuate the user’s one or more intents. In this case, the agent may indicate to the system that the fillable form does not correlate with the user intent. The system, in response to this indication, will generate and transmit one or more updated fillable forms. In an embodiment, the form itself does not correlate with the user intent. The system may, in this embodiment, generate a different fillable form using some or all of the information of the previous form. Further, the system may utilize the indication provided by the user to retrain the natural language processing model based on the indication, the retraining adjusting the weights to improve predictability of the natural language processing model.

In some embodiments, the system receives, from the agent device and in response to transmitting the one or more fillable forms to the agent device, (a) a completed version of each respective form of the one or more fillable forms, and (b) an authorization indication authorizing transmission of the completed version of each respective form of the one or more fillable forms to a user device of the user. This may be needed, for example, to obtain the user’s authorization or acknowledgement that the information included in the form filled bout by the user is correct. In response, the system may transmit the completed version of each respective form of the one or more fillable forms to the user device for review by the user.

Aspects of the present invention are described herein with reference to flowchart illustrations and/or block diagrams of computer-implemented methods and computing systems according to embodiments of the invention. It will be understood that each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computing system facilitating natural language processing for conversational data, the system comprising:
at least one processor;
a communication interface communicatively coupled to the at least one processor; and
a memory device storing executable code that, when executed, causes the at least one processor to:
train, using training data, a natural language processing model based on data processing inputs and a selected training algorithm to generate a trained natural language processing model, the training including:
iteratively predicting which of one or more key statements should be included in a prediction of one or more user intents, the predicting being based on at least one key statement ascertained from user conversation data;
testing and comparing the one or more key statements predicted during each iteration against a target variable;
indicating, via a feedback loop, for each iteration whether modifications to weights assigned to certain key statements are necessary to improve predictability of the target variable; and
updating calculations used to predict which of one or more key statements should be included in prediction of one or more user intents by adjusting the weights, thereby reducing the error and improving predictability of the target variable;
receive, over a network from an agent device, data of a conversation between an agent and a user;
predict, using the trained natural language processing model and from at least one key statement predicted to indicate intent, one or more user intents of the user from the data of the conversation;
generate, based on the one or more predicted user intents, one or more pre-filled forms predicted to effectuate the one or more predicted user intents, the one or more pre-filled forms including generated text that includes information derived from the data of the conversation; and
transmit, to the agent device, the one or more pre-filled forms.

2. The computing system of claim 1, wherein the data processing inputs used to train the natural language processing model are selected from the group consisting of an audio dataset, a written dataset, and a combination thereof.

3. The computing system of claim 1, wherein the executable code, when executed, further causes the at least one processor to:
receive, via the network in response to the one or more pre-filled forms being transmitted, an indication that the one or more pre-filled forms do not correlate with the one or more predicted user intents;
generate and transmit, to the agent device, one or more updated pre-filled forms; and
retrain the natural language processing model based on the indication, the retraining adjusting the weights to improve predictability of the natural language processing model.

4. The computing system of claim 1, wherein the generated text further includes additional information derived from a user profile of the user.

5. The computing system of claim 4, wherein the additional information is derived from stored data selected from the group consisting of personal data, demographic data, transactional data, behavioral data, user engagement data, customer feedback data, and attitudinal data.

6. The computing system of claim 1, wherein the data of the conversation is derived from a communication medium selected from the group consisting of Internet messaging app, a text message, a Short Message Service (SMS), a telephone call, in-person communication, and a combination thereof.

7. The computing system of claim 1, wherein generating the one or more pre-filled forms includes identifying one or more form fields and auto-filling the one or more form fields with the generated text.

8. The computing system of claim 1, wherein the executable code, when executed, further causes the at least one processor to:
receive, from the agent device and in response to transmitting the one or more pre-filled forms to the agent device, an authorization indication authorizing transmission of the one or more pre-filled forms to a user device of the user; and
transmit the one or more pre-filled forms to the user device for review by the user.

9. The computing system of claim 8, wherein the one or more pre-filled forms are transmitted to the agent device in real time during the conversation, and the one or more pre-filled forms are transmitted to the user device in real time during the conversation.

10. A computer-implemented method facilitating natural language processing for conversational data, the method comprising:
training, by a computer, a natural language processing model based on data processing inputs and a selected training algorithm to generate a trained natural language processing model, the training including:
iteratively predicting which of one or more key statements should be included in a prediction of one or more user intents, the predicting being based on at least one key statement ascertained from user conversation data;
testing and comparing the one or more key statements predicted during each iteration against a target variable;
indicating, via a feedback loop, for each iteration whether modifications to weights assigned to certain key statements are necessary to improve predictability of the target variable; and
updating calculations used to predict which of one or more key statements should be included in prediction of one or more user intents by adjusting the weights, thereby reducing the error and improving predictability of the target variable;
receiving, over a network from an agent device, data of a conversation between an agent and a user;
predicting, using the trained natural language processing model and from at least one key statement predicted to indicate intent, one or more user intents of the user from the data of the conversation;
generating, based on the one or more predicted user intents, one or more pre-filled forms predicted to effectuate the one or more predicted user intents, the one or more pre-filled forms including generated text that includes information derived from the data of the conversation; and
transmitting, to the agent device, the one or more pre-filled forms.

11. The computer-implemented method of claim 10, wherein the data processing inputs used to train the natural language processing model are selected from the group consisting of an audio dataset, a written dataset, and a combination thereof.

12. The computer-implemented method of claim 10, further comprising:
receiving, via the network in response to the one or more pre-filled forms being transmitted, an indication that the one or more pre-filled forms do not correlate with the one or more predicted user intents;
generating and transmitting, to the agent device, one or more updated pre-filled forms; and
retraining the natural language processing model based on the indication, the retraining adjusting the weights to improve predictability of the natural language processing model.

13. The computer-implemented method of claim 10, wherein the generated text further includes additional information derived from a user profile of the user.

14. The computer-implemented method of claim 10, wherein the additional information is derived from stored data selected from the group consisting of personal data, demographic data, transactional data, behavioral data, user engagement data, customer feedback data, and attitudinal data.

15. The computer-implemented method of claim 10, wherein the data of the conversation is derived from a communication medium selected from the group consisting of Internet messaging app, a text message, a Short Message Service (SMS), a telephone call, in-person communication, and a combination thereof.

16. The computer-implemented method of claim 10, further comprising:
receiving, from the agent device and in response to transmitting the one or more pre-filled forms to the agent device, an authorization indication authorizing transmission of the one or more pre-filled forms to a user device of the user; and
transmitting the one or more pre-filled forms to the user device for review by the user.

17. The computing system of claim 16, wherein the one or more pre-filled forms are transmitted to the agent device in real time during the conversation, and the one or more pre-filled forms are transmitted to the user device in real time during the conversation.

18. A computing system, comprising:
at least one processor;
a communication interface communicatively coupled to the at least one processor; and
a memory device storing executable code that, when executed, causes the at least one processor to:
train, using training data, a natural language processing model based on data processing inputs and a selected training algorithm to generate a trained natural language processing model, the training including:
iteratively predicting which of one or more key statements should be included in a prediction of one or more user intents, the predicting being based on at least one key statement ascertained from user conversation data;
testing and comparing the one or more key statements predicted during each iteration against a target variable;
indicating, via a feedback loop, for each iteration whether modifications to weights assigned to certain key statements are necessary to improve predictability of the target variable; and
updating calculations used to predict which of one or more key statements should be included in prediction of one or more user intents by adjusting the weights, thereby reducing the error and improving predictability of the target variable;
receive, over a network from an agent device, data of a conversation between an agent and a user;
predict, using the trained natural language processing model and from at least one key statement predicted to indicate intent, one or more user intents of the user from the data of the conversation;
correlate, based on the one or more predicted user intents, one or more fillable forms to the one or more predicted user intents, the one or more fillable forms including form fields for entering information; and
transmit, to the agent device, the one or more fillable forms.

19. The computing system of claim 18, wherein the executable code, when executed, further causes the at least one processor to:
receive, via the network in response to the one or more fillable forms being transmitted, an indication that the one or more fillable forms do not correlate with the one or more predicted user intents;
generate and transmit, to the agent device, one or more updated fillable forms; and
retrain the natural language processing model based on the indication, the retraining adjusting the weights to improve predictability of the natural language processing model.

20. The computing system of claim 18, wherein the executable code, when executed, further causes the at least one processor to:
receive, from the agent device and in response to transmitting the one or more fillable forms to the agent device, (a) a completed version of each respective form of the one or more fillable forms, and (b) an authorization indication authorizing transmission of the completed version of each respective form of the one or more fillable forms to a user device of the user; and
transmit the completed version of each respective form of the one or more fillable forms to the user device for review by the user.
